(19) United States
(12) Patent Application Publication
(10) Pub. No.: US 2026/0029170 A1
(43) Pub. Date: Jan. 29, 2026

(54) METHODS, SYSTEMS, AND DEVICES FOR IONOCALORIC HEATING AND COOLING

(71) Applicant: The Regents of The University of California, Oakland, CA (US)

(72) Inventors: Drew LILLEY, Berkeley, CA (US); Ravi PRASHER, Danville, CA (US)

(21) Appl. No.: 18/997,477

(22) PCT Filed: Jul. 21, 2023
(86) PCT No.: PCT/US2023/028408

§ 371 Date: Jan. 21, 2025

Related U.S. Application Data
(60) Provisional application No. 63/391,816, filed on Jul. 25, 2022.

(51) Int. Cl. F25B 21/00

(52) U.S. Cl. CPC F25B 21/00; F25B 2321/001

(57) ABSTRACT

Disclosed herein are methods, systems, and devices heating and cooling via an ionocaloric cycle. Methods include providing a first material in a solid state, combining the first material with a second material, wherein the second material provides an electrochemical field to the first material to reduce the melting point of the first material, and allowing the first material to melt, wherein the first material extracts heat from a cold reservoir upon melting. The method further includes separating the first material from the second material by a separation technique using a voltage applied to a combination of the first material and the second material and allowing the first material to precipitate, wherein the first material releases heat to a hot reservoir during precipitation.

### CROSS-REFERENCE TO RELATED APPLICATIONS

This application claims the benefit under 35 U.S.C. § 119(e) of U.S. Provisional Patent Application No. 63/391,816, filed on Jul. 25, 2022, which is incorporated herein by reference in its entirety for all purposes.

### STATEMENT OF GOVERNMENT SUPPORT

This invention was made with government support under Contract No. DE-AC02-05CH11231 awarded by the U.S. Department of Energy. The government has certain rights in the invention

### TECHNICAL FIELD

This disclosure relates generally to heat movers, and more particularly to an ionocaloric heating and cooling cycle.

### BACKGROUND

Heating and cooling systems move and transfer heat from work input into the system. Such systems may operate on one or more of several principals including phase change heat transfer via compression, air to liquid heat exchange, liquid to liquid heat exchange, etc. These heating systems can be used for climate control, refrigeration, etc.

### SUMMARY

Disclosed herein are methods, systems, and devices for ionocaloric heating and cooling. Methods include providing a first material in a solid state, combining the first material with a second material, wherein the second material provides an electrochemical field to the first material to reduce the melting point of the first material and allowing the first material to melt, wherein the first material extracts heat from a cold reservoir upon melting. Methods further include separating the first material from the second material by a separation technique using a voltage applied to a combination of the first material and the second material and allowing the first material to precipitate, wherein the first material releases heat to a hot reservoir during precipitation.

In some embodiments, the first material has a melting point at or above an ambient temperature. In some embodiments, the second material comprises an ion concentration to provide the electrochemical field. In some embodiments, the second material comprises at least one of sodium iodide, potassium iodide, magnesium nitrate, magnesium chloride, ammonium nitrate, potassium nitrate, potassium chloride, sodium thiosulfate, lithium bromide, lithium iodide, lithium chloride, lithium carbonate, water, or ethanol. In some embodiments, the separation technique comprises electrodialysis or Faradaic deionization. In some embodiments, the electrodialysis comprises separating the first material from the second material by applying the voltage across electrode compartments comprising iodide triiodide redox couples. In some embodiments, the first material comprises at least one of ethylene carbonate, magnesium nitrate hexahydrate, magnesium chloride hexahydrate, sodium thiosulfate hexahydrate, sodium acetate trihydrate, nickel nitrate hexahydrate, iron nitrate hexahydrate, Iron chloride hexahydrate, or cadmium nitrate tetrahydrate.

Systems include a mixing chamber to combine a first material in a solid state with a second material wherein the second material provides an electrochemical field to the first material to reduce the melting point of the first material and a melting chamber allowing the first material to melt, wherein the melting chamber is coupled to a cold reservoir and wherein the first material extracts heat from the cold reservoir upon melting. Systems further include a separating chamber to separate the first material from the second material via a separation technique comprising a voltage applied to a combination of the first material and the second material and a precipitation chamber allowing the first material to precipitate, wherein the first material releases heat to a hot reservoir coupled to the precipitation chamber during precipitation.

An apparatus includes a mixer to combine a first material in a solid state with a second material wherein the second material provides an electrochemical field to the first material to reduce the melting point of the first material, a melter allowing the first material to melt, wherein the melting chamber is coupled to a cold reservoir and wherein the first material extracts heat from the cold reservoir upon melting, a separator to separate the first material from the second material via a separation technique comprising a voltage applied to a combination of the first material and the second material, and a precipitator allowing the first material to precipitate, wherein the first material releases heat to a hot reservoir coupled to the precipitation chamber during precipitation.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates an example system for ionocaloric cooling, configured in accordance with some embodiments.

FIG. 2 illustrates an example regenerative ionocaloric cycle, in accordance with some embodiments.

FIG. 3A illustrates a temperature-entropy diagram of an example of an ionocaloric process of heating and cooling, configured in accordance with some embodiments.

FIG. 3B illustrates a temperature-ion concentration diagram of an example ionocaloric process of heating and cooling, configured in accordance with some embodiments.

FIG. 4 illustrates an example of a separator of an ionocaloric heating and cooling system, configured in accordance with some embodiments.

FIG. 5A illustrates another example of a separator of an ionocaloric heating and cooling system, configured in accordance with some embodiments.

FIG. 5B illustrates another example of a separator of an ionocaloric heating and cooling system, configured in accordance with some embodiments.

FIG. 6 illustrates an example of a precipitator of an ionocaloric heating and cooling system, configured in accordance with some embodiments.

FIG. 7 illustrates an example of a mixer of an ionocaloric heating and cooling system, configured in accordance with some embodiments.

FIG. 8 illustrates an example of a melter of an ionocaloric heating and cooling system, configured in accordance with some embodiments.

FIG. 9 illustrates a flow chart of a method of ionocaloric heating and cooling, implemented in accordance with some embodiments.

FIG. 10 illustrates a flow chart of a method of ionocaloric heating and cooling, implemented in accordance with some embodiments.

FIG. 11 depicts a table of potential materials to be used for ionocaloric heating and cooling, according to some embodiments of the disclosure.

FIG. 12 depicts a table of potential ionic materials to be used for ionocaloric heating and cooling, according to some embodiments of the disclosure.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

Currently, cooling techniques are dominated by vapor compression technologies in which a gas is compressed (e.g., by heating) and then expanded (e.g. cooled). The liquids used in these vapor compression technologies include hydrofluorocarbons (HFCs) which are significant contributors to global warming and thus need to be phased out. Other liquid-based alternatives to HFCs, such as hydrofluoroolefins (HFOs), which have a lesser global warming effect but are still slightly flammable, have smaller power densities and coefficients of performance as compared to HFCs and pose other environmental concerns. Non-vapor compression based refrigeration technologies using solid-state material are being developed, however are not yet cost effective.

The ionocaloric effect is the thermal response to a changing ionic environment surrounding a solid phase, driven by an electrochemical field. Physically, the ionocaloric effect manifests within first-order phase boundaries by lowering the melting point of a solid below the ambient temperature upon the addition of ions to its surroundings (e.g., by applying an electrochemical field). Under such an applied field, the solid, which becomes most stable as a liquid, melts. Melting of the solid requires energy. Accordingly, if the system is insulated from its surroundings (e.g., adiabatic), the material in the solid form uses its own energy to melt, thus lowering its own temperature by endothermically converting some solid to the liquid phase. This process continues until the temperature of the solid is equal to the new melting temperature, which is dictated both by the strength of the applied electrochemical field and the phase boundary of the caloric material.

Various embodiments disclosed herein provide for use of the ionocaloric effect in a thermodynamic cycle for refrigeration. The thermodynamic cycle may include four steps. The first step may include mixing a caloric material in a solid form with an electrolyte solution (e.g., a liquid including an ion). The second step may include allowing the caloric material to melt and extracting heat into the caloric material from a cold reservoir. The third step may include separating the electrolyte solution from the caloric material. For example, a voltage may be applied to the mixture to separate electrolyte solution from the caloric material. The fourth step may include allowing the caloric material to precipitate or crystallize into solid form, releasing heat into a hot reservoir.

Ideal refrigerants in the ionocaloric cycle may include materials that experience large adiabatic temperature changes and isothermal entropy changes. This allows for high temperature spans and large refrigeration capacities (e.g., the amount of heat absorbed per cycle). In addition, the melting point of the materials dictates the maximum operating temperature of the cycle, so the ideal materials may have melting points above room temperature. The lowest operating temperature in the cycle is determined by either (1) the max adiabatic temperature change, or (2) the maximum melting point depression that can be achieved for a given material/salt combination.

The maximum adiabatic temperature change for the ionocaloric material, independent of the salt used in conjunction with the material, scales with the ratio of latent heat to specific heat, ΔTₘₐₓ≈ΔHₛₗ/Cₚ. However, the amount of salt needed to drive this melting point depression is related to the ionocaloric material's cryoscopic constant, k_{f}=RMT²/ΔHₛₗ, which can be used to relate the expected melting point depression to the molality for a given solvent/salt combination: ΔT_{D}=−ik_{f}[m], where R is the ideal gas constant, M is the molar mass of the ionocaloric material, Tₘ is the melting point, ΔHₛₗ is the enthalpy of fusion, i is the van′t Hoff Factor (number of particles the salt dissociates into), and [m] is the molality.

These simple relations demonstrate that a material with a high enthalpy change will enable large adiabatic temperature changes but may require higher salt concentrations to move the phase boundary. To support the higher salt concentrations needed to move the phase boundaries for lower to moderate cryoscopic constant materials, the ionocaloric material may have a high salt solubility. In some examples, the material's dielectric constant can be used as a broad indicator of ability to solubilize ionic compounds. In general, materials with higher dielectric constants are more likely to exhibit high solubilities.

Therefore, ideal ionocaloric materials may have one or more of the following properties: (1) melting point greater than ambient temperature, (2) large enthalpy of fusion (3) high cryoscopic constant (4) large maximum adiabatic temperature change, and (5) large dielectric constant.

Accordingly, embodiments disclosed herein provide for heating and cooling in an ionocaloric cycle that does not use greenhouse contributing materials. Additionally, the disclosed ionocaloric cycle provides for large heating and cooling capacity at room temperature. For example, room temperature may include temperatures in the range approximately 10 degrees C. to 30 degrees C. In another example, room temperature may include temperatures in the range of 0 degrees C. to 50 degrees C. In another example, room temperature may include temperatures in the range of 18 degrees C. to 24 degrees C. Furthermore, embodiments disclosed herein allow for various applications of heating and cooling at various temperatures. In some embodiments, the process describes herein is not used for refrigeration (e.g., embodiments are not used to provide temperatures of a cool reservoir below 0 degrees C.).

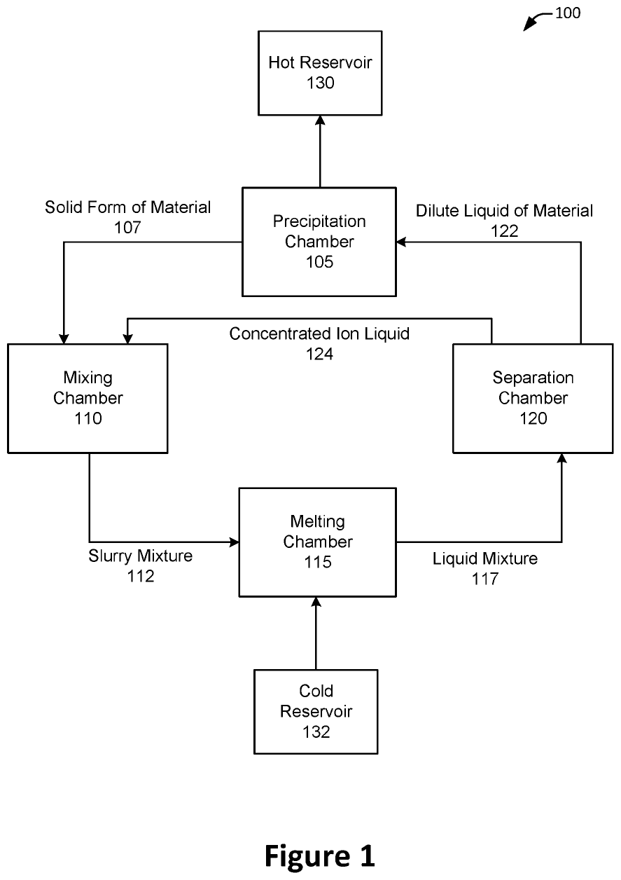

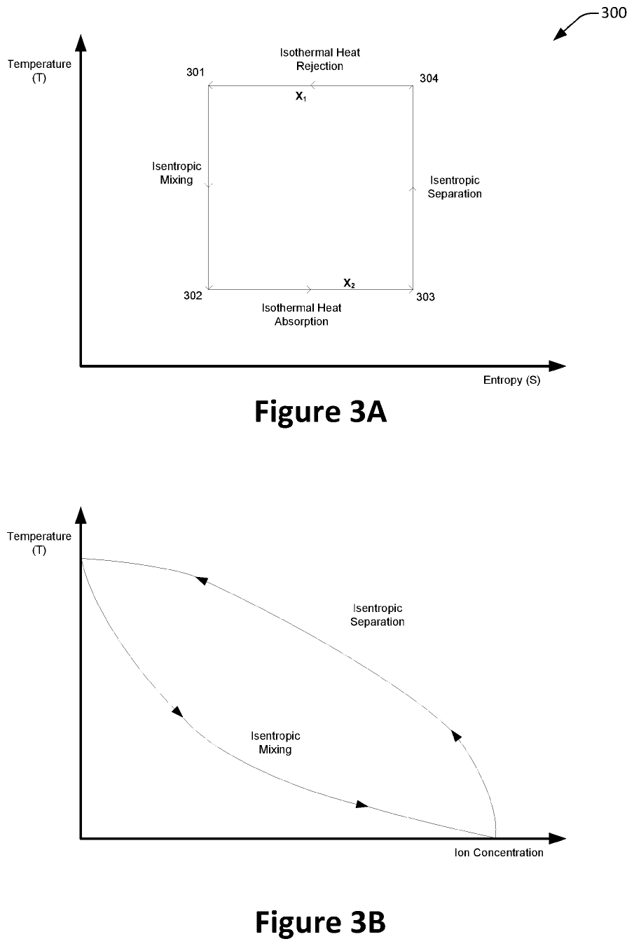

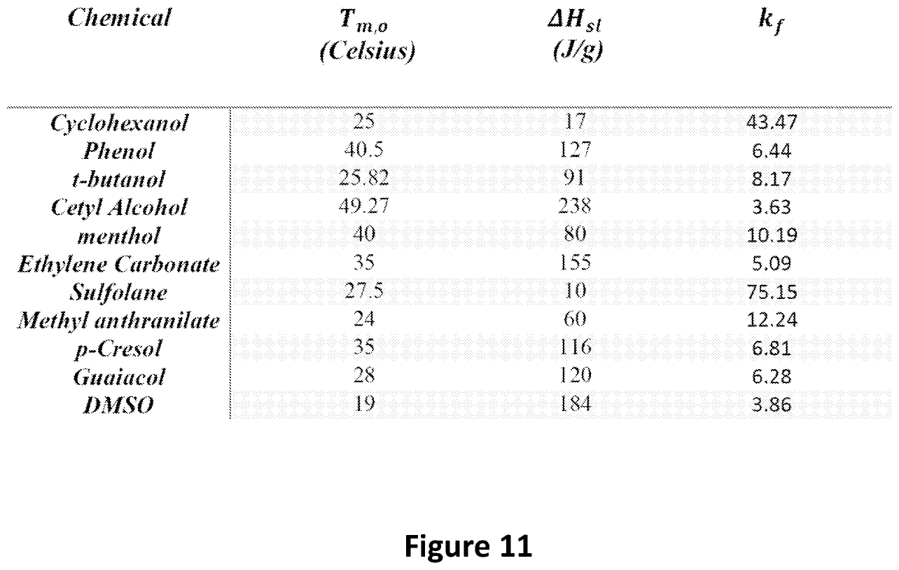

FIG. 1 illustrates an example system 100 for ionocaloric cooling, configured in accordance with some embodiments. System 100 includes a precipitation chamber 105, a mixing chamber 110, a melting chamber 115, and a separation chamber 120. In some embodiments, a solid form of a caloric material 107 may be provided to a mixing chamber 110 (e.g., from precipitation chamber 105). In some examples, the solid form of the caloric material 107 output from the precipitation chamber 105 to the mixing chamber 110 may be a complete solid form (e.g., which may require transport via conveyor or other similar means) or may be in the form of a slurry with a portion of the slurry in solid form such that the slurry may be pumped (e.g., via piping) to the mixing chamber 110. The caloric material may be a material with a melting point at or above ambient temperature (e.g., such that the material is in a solid state at ambient or room temperature). For example, the caloric material may be one of the materials listed in FIG. 11. In some embodiments, the caloric material may include magnesium nitrate hexahydrate, magnesium chloride hexahydrate, sodium thiosulfate hexahydrate, sodium acetate trihydrate, nickel nitrate hexahydrate, iron nitrate hexahydrate, Iron chloride hexahydrate, cadmium nitrate tetrahydrate, room temperature liquid salts such as 1-Butyl-2,3-dimethlynlimidazolium tetrafluoroborate puruum and 1-ethyl-3-methylimidazolium nitrate, polyalcohols such as ervhritol, d-mannitol, d-dulcitol, inositol, neopentyl glycol, fatty acids such as paraffin waxes (heptadecane, octadecane) and lauric, myristic, palmitic, and stearic acids. The solid form of the caloric material 107 may be combined with an electrolyte solution (e.g., concentrated ion liquid 124) at the mixing chamber 110. The mixing chamber 110 may include a mechanism for mixing the electrolyte solution with the caloric material. Once mixed, a slurry mixture 112 of the combined caloric material and electrolyte solution is provided to the melting chamber 115. The melting chamber 115 may be coupled to a cold reservoir 132. Although depicted as separate, in some embodiments, the mixing chamber 110 and the melting chamber 115 may be a single integrated unit or chamber for mixing and melting of the caloric material. As the caloric material melts due to the electrochemical field provided by the electrolyte solution, the caloric material may drop in temperature due to the phase change. The caloric material may thus extract heat from the cold reservoir 132. Although depicted as separate, the cold reservoir 132 may be incorporated with the melting chamber 115 as a single integrated unit. The resulting liquid mixture 117 is then transported to a separation chamber 120 where a separation process is applied to the liquid mixture 117 of the caloric material and ion liquid. The separation process applied within the separation chamber 120 may include a voltage applied across the liquid mixture. For example, the separation process may include electrodialysis, as described in more detail with respect to FIG. 3. In some examples, the separation process may include distillation, reverse osmosis, other voltage applied separation process, or any other process for separation of mixed materials. The separation chamber 120 may thus separate the liquid mixture into a dilute liquid of the caloric material 122 and a concentrated ion liquid 124. The dilute liquid of caloric material 122 may then be provided to the precipitation chamber 105 where the material is allowed to precipitate (e.g., crystallize). Precipitate and crystallize may be used interchangeably herein to mean converting a material from a liquid form to a solid form. Accordingly, the precipitation chamber may also be referred to as a crystallization chamber. The precipitation chamber 105 may be coupled to a hot reservoir 130. As the caloric material precipitates and crystallized in the precipitation chamber 105, the material rejects heat that is extracted into the hot reservoir at 20-200° C. 130. Although depicted as separate, the hot reservoir 130 may be incorporated with the precipitation chamber 105 as a single integrated unit. The concentrated ion liquid 124 is then provided directly back to the mixing chamber 110 to continue the cycle.

In some embodiments, the caloric material may be a material with a melting point above room temperature, a eutectic well below room temperature, and a high enthalpy of fusion as well as high cryoscopic constants so that large temperature changes can be achieved using small amounts of electrolytes. In some embodiments, the caloric material may be ethylene carbonate (EC) and the ionic material may be sodium iodide (NaI). The (EC-NaI) ionocaloric system may include a pure melting point of Tₘₑₗₜ=36.4° C., a eutectic transition at T_{eutectic}=6.4° C., and a relatively high latent heat of fusion Δ H_{fus}=204.6 J mL−1 (as compared with Δ H_{fusion}≈330 J mL-1 for water, which has one of the highest entropies of fusion of known near-room temperature molecules). The EC-NaI system is a CO₂-negative, environmentally benign, nonhazardous, zero-GWP, nontoxic, and nonflammable mixture. EC is a common additive to battery electrolytes (e.g., lithiumion), can be made stable over a long lifetime, and has shown good cyclability and stability.

Additionally, in some embodiments the ionocaloric cycle may include adding water to a salt hydrate in a solid form at the mixing chamber 110 and providing the mixture to the melting chamber 115. The melting point of the salt hydrate may be reduced by the added water, similar to the addition of ions to a caloric material as described herein. Accordingly, the salt hydrate is cooled when the water is added via the same ionocaloric principles described herein. The salt hydrate mixture may then extract heat from the cold reservoir 132 and be passed to the separation chamber 120. The separation chamber 120 may perform a separation technique to separate the water from the salt hydrate. For example, the separation technique may include operations such as evaporation, distillation, filtering (e.g., reverse osmosis), or any other separation technique. The separated water may be retuRN ed directly to the mixing chamber 110 for further cycles while the concentrated salt hydrate liquid may be provided to the precipitation chamber 105 where it is allowed to crystallize and release heat to the hot reservoir 130. The cycle may then be repeated by providing the solid form of the salt hydrate from the precipitation chamber 105 to the mixing chamber 110.

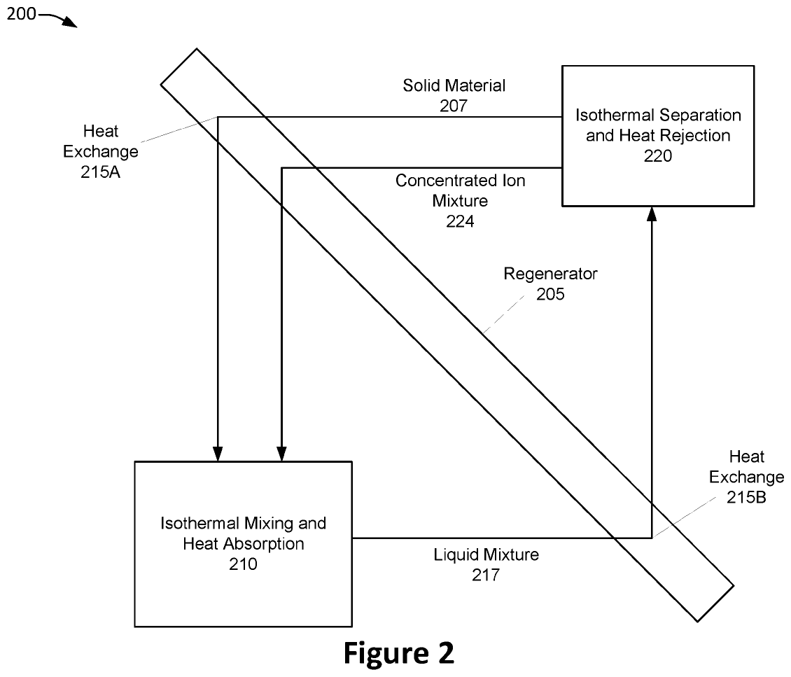

FIG. 2 illustrates an example regenerative ionocaloric cycle 200, in accordance with some embodiments. The cycle 200 includes isothermal mixing and heat absorption 210 where a solid material 207 (e.g., solid form of material 107 of FIG. 1) is mixed with a concentrated ion mixture 224 to reduce a melting point of the solid material and absorb heat as the solid material is converted to a liquid. The isothermal mixing and heat absorption 210 may correspond to processes occurring at mixing chamber 110 and melting chamber 115 as described with respect to FIG. 1. In some examples, the isothermal mixing and heat absorption 210 results in a liquid mixture 217. The liquid mixture 217 may run through a heat exchange 215B where the liquid mixture absorbs heat from the regenerator 205. Isothermal separation and heat rejection 220 may be performed on the liquid mixture 217. For example, the liquid mixture 217 may be separated back into the solid material 207 and the concentrated ion mixture 224. During the isothermal separation and heat rejection 220 the crystallization of the solid material (e.g., due to the return of the melting point to above ambient temperature0 may cause the solid material 207 to reject heat (e.g., to a hot reservoir). In some embodiments, the isothermal separation and heat rejection 220 may correspond to processes occurring at the separation chamber 120 and the precipitation chamber 105 as described with respect to FIG. 1. The solid material 207 may be transported through heat exchange 215A where heat is given to the regenerator 205 from the solid material 207. The cycle 200 may then repeat as the solid material 207 is again mixed with the concentrated ion mixture 224 at the isothermal mixing and heat absorption 210 stage.

FIG. 3A illustrates a diagram of an ionocaloric cooling cycle according to embodiments of the present disclosure. The depicted diagram includes entropy (S) on the x-axis and temperature of a caloric material on the y-axis. The cycle may begin at point 301, where the caloric material is in a solid state with a constant concentration of ion liquid X₁, where X₁ may be zero or at least negligible. Isentropic mixing is then performed where an increasing amount of ionic material (e.g., ion liquid or electrolyte solution) is added to and mixed with the caloric material. As the amount of ionic material increases, the melting point of the caloric material is reduced to point 302, where the melting point is reduced to a desired temperature based on the implementation or design of the cycle. As discussed above, in an adiabatic environment the caloric material has to use its own internal heat energy to produce the phase change to liquid form, thus cooling the caloric material to the new melting point. The melting point may be based on the caloric properties of the caloric material and the concentration of ions in the mixture. For example, the concentration of ions X₂ at point 302 may drop the melting point of the caloric material to below ambient temperature to cause the phase change. Once at point 302, the caloric material may absorb heat isothermally (e.g., while maintaining the melting point temperature) due to the internal energy required to produce the phase change. At point 303, once isothermal heat absorption has occurred, the ion material is separated from the caloric material (e.g., isentropic separation.) In some embodiments, the ions may be removed from the caloric material via an applied voltage to the mixture. In some embodiments, the ions are removed via a form of electrodialysis, as discussed in more detail below with respect to FIG. 3. At point 304, once the ion material is separated from the caloric material, the melting point of the material may return to the original temperature, thus causing a phase change back into a solid. For example, the liquid caloric material may precipitate or crystallize and reject heat as it does so. The crystallization may occur isothermally as the caloric material rejects heat collected between points 302 and 303. The cycle may then return to point 301 where the caloric material is returned to a solid state.

FIG. 3B illustrates an ionocaloric cycle with respect to ion concentration in a caloric material, according to some embodiments of the present disclosure. The depicted diagram includes ion concentration on the x-axis and temperature of a caloric material on the y-axis. As can be seen, the temperature of the caloric material drops as isentropic mixing occurs with increasing concentrations of the ion material. Additionally, as the ion concentration is reduced during isentropic separation the caloric material increases back to its original temperature.

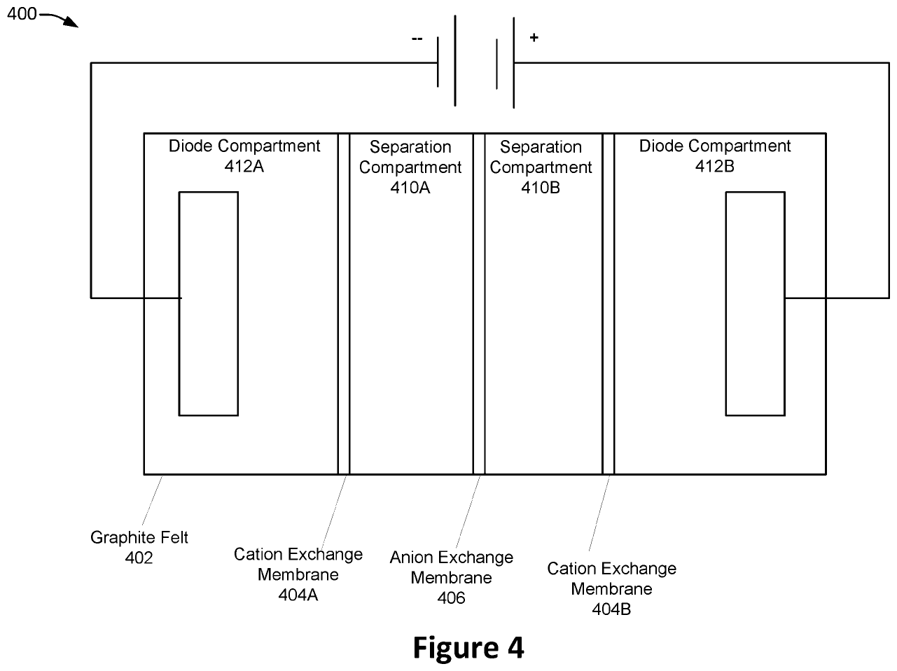

FIG. 4 illustrates a diagram of an example of a separator 400 of an ionocaloric heating and cooling system, according to some embodiments of the present disclosure. The separator 400 includes a diode compartments 412A-B, separation compartment 410A-B, cation exchange membranes 404A-B and anion exchange membrane 406. In some examples, the cation exchange membranes 404A-B may alternatively be an anion exchange membrane and the anion exchange 406 may be a cation exchange membrane. The diode compartments 412A-B may each include a graphite felt 402 across which a voltage is applied. In some examples, the voltage may be relatively small (e.g., between approximately 0.01 Volts to 2 Volts) In some examples, the voltage may be about 0.4 Volts. Additionally, the diode compartments 412A-B may include a redox coupled (e.g., iodide triiodide redox couples). In some embodiments, the diode compartments 412A may include graphite felt, graphite paper, carbon felt, carbon paper, stainless steel foil and/or mesh, nickel foil and/or mesh/foam, platinum coated foils, and ferricyanide/feroocyanide and bromine/bromide redox couples.

In some embodiments, the separator 400 may receive a liquid mixture of a caloric material and an ion liquid. The separator 400 may initially receive the liquid mixture in equal concentrations in the separation compartments 410A-B. The voltage applied to the graphite felt 402 in the diode compartments 412A-B may cause one or more chemical reactions that drive cations across the cation exchange membrane 404A from separation compartment 410A to diode compartment 412A and across cation exchange membrane 404B from diode compartment 412B to separation compartment 410B. The cation exchange may further drive anions across anion exchange membrane 406 from separation compartment 410A to separation compartment 410B. After sufficient time of applying the voltage, the result may be that only the caloric material remains in separation compartment 410A while the separation compartment 410B includes only an ion concentration. Thus, the caloric material separated in liquid form may be provided to a precipitator to return to solid form once the electrochemical field has been removed and the melting point is once again above ambient temperature. The ion concentration can be returned to a mixer for reuse in the ionocaloric cycle.

In some embodiments, the electrode compartments are filled with 0.5 M NaI₃ and 1.5 M NaI, forming a symmetric cell. Current is driven across the cell using an iodide triiodide redox couple. At the negative electrode, triiodide is reduced, following

$${I}_{3}^{-} + 2 {e}^{-} \to 3 {I}^{-} ,$$

and at the positive electrode, iodide is oxidized such that

$$3 {I}^{-} \to {I}_{3}^{-} + 2 {e}^{-} .$$

The reactions may be symmetric and thus the change in Gibbs free energy between the oxidized and reduced states is zero. Accordingly, the reaction proceeds at any non-zero voltage applied across the electrodes. At higher potentials [˜1V higher than the iodide triiodide couple versus saturated calomel electrode (SCE)], triiodide is further oxidized to pure iodine,

$$2 {I}_{3}^{-} \to 3 {I}_{2} + 2 {e}^{-} .$$

I₂ is soluble in EC, so it dissolves back into the electrode solution and, upon circulation, either combines with an I⁻ to reform

$${I}_{3}^{-}$$

or gets reduced at the negative electrode to the same result. Positive ions (Na⁺) will then be driven toward the negative electrode upon reduction of

$${I}_{3}^{-} .$$

Na⁺ can cross the cation-exchange membranes but are prevented from crossing the anion-exchange membrane (e.g., by Donnan exclusion). Likewise, the negative I⁻ ions will be driven toward the positive electrode upon oxidation of I⁻ and may cross the anion-exchange membrane, but they are prevented from crossing the cation-exchange membranes. Because the membranes are selective to only one type of ion, one compartment will eventually become completely depleted of ions while the other becomes concentrated.

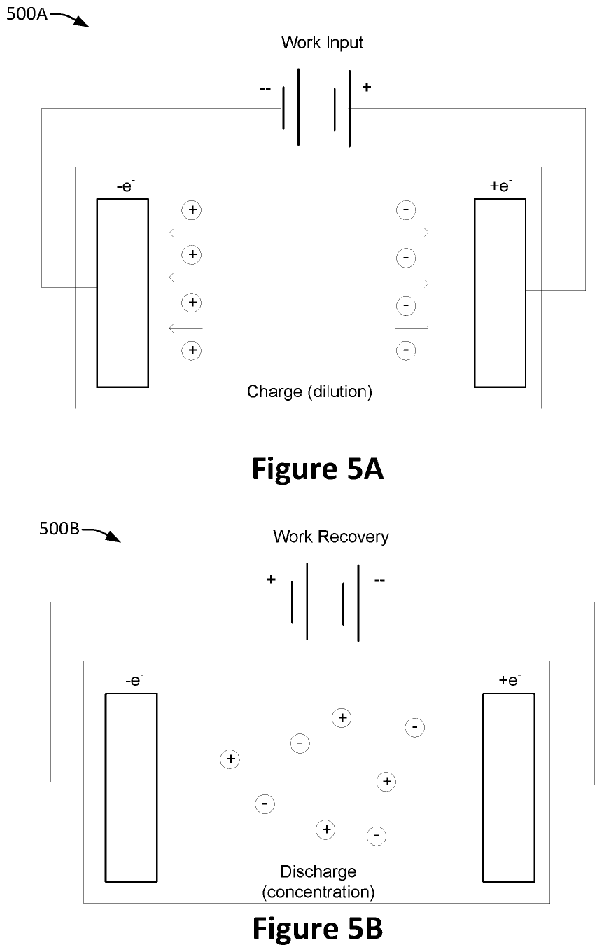

FIGS. 5A and 5B illustrate a separator using capacitive deionization or Faradaic deionization, according to some embodiments. As depicted in 5A, a voltage may be applied across electrodes which causes ions in the solution to drift toward the electrodes depending on the charge of the ions. Accordingly, the ions may be drawn out of the solution toward the electrodes causing dilution of the caloric material. The diluted caloric material may then be transported from the separator (e.g., to a crystallizer/precipitator). As depicted in FIG. 5B, once the diluted caloric material is removed, the voltage on the electrodes may be reversed to undo the work performed on the ions. The result may be a concentrated electrolyte solution of ions which may be provided to a mixer, as described with respect to FIG. 1.

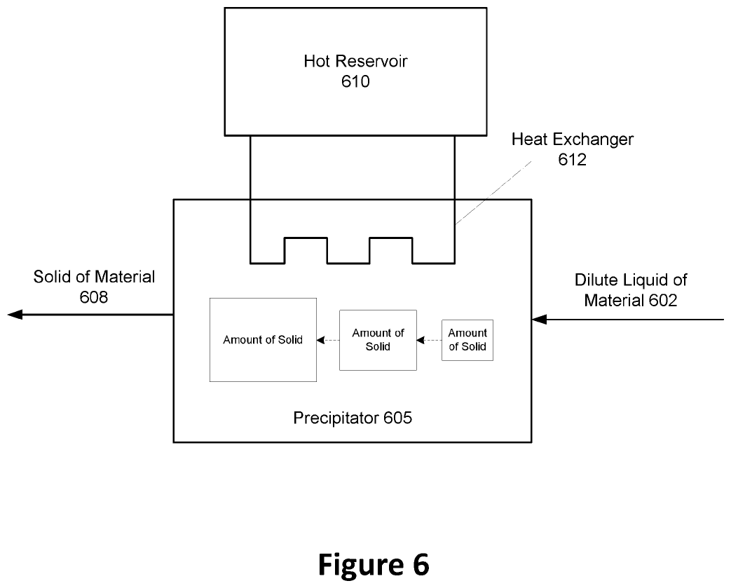

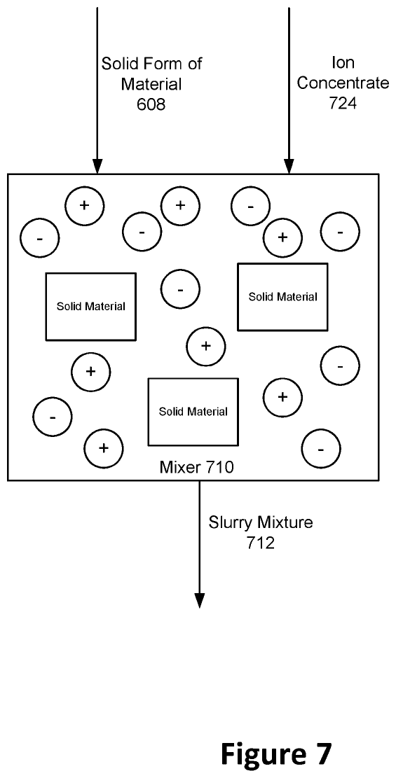

FIG. 6 illustrates an example of a precipitator of an ionocaloric heating and cooling system, configured in accordance with some embodiments. As depicted, a precipitator 605 may be coupled to a hot reservoir 610 (e.g., via a heat exchanger 612). Precipitator 605 may be the same or similar to precipitation chamber 105 as described with respect to FIG. 1. The precipitator 605 may receive the dilute liquid of caloric material 602 and allow the caloric material 602 to precipitate (e.g., crystallize). As the caloric material precipitates, it rejects excess heat to remain at the same temperature (e.g., the melting point/freezing point) as its entropy decreases. The precipitator 605 may operate at ambient temperature without additional cooling applied to the precipitator 605. Once the precipitator 605 may then output the solid caloric material 608 to be returned to a mixer (e.g., as described in FIG. 7 below). In some embodiments, the hot reservoir 610 may be used for heating in any potential context such as in a boiler, hot water heater, central air, air source steam generating heat pumps, or any other use. For example, an air source steam generating heat pump may extract heat from air heated by the ionocaloric heating cycle. The heat extracted by the air source steam generating heat pump may be used to generate steam from the high concentration of heat provided by the ionocaloric heating cycle.

FIG. 7 illustrates an example of a mixer 710 of an ionocaloric heating and cooling system, configured in accordance with some embodiments. Mixer 710 may be the same or similar to mixing chamber 110 describe with respect to FIG. 1. Mixer 710 may receive the solid form of the caloric material 608 (e.g., from a precipitator or other source). The mixer 710 may further receive an ion concentrate 724, such an ion liquid (e.g., a solution including a large concentration of ions). In some embodiments, the mixer 710 may include a mechanical means to mix the ion concentrate 724 with the solid material. For example, a stirring mechanism may be included in the mixer 710. The combination of solid material and ion concentrate 724 may be output from the mixer 710 as a slurry mixture 712 before the solid material has the opportunity to melt due to the lowered melting point of the caloric material in the presence of the electrochemical field applied by the ion concentrate. In some embodiments, although depicted separately, the mixer and the melter may be combined into a single chamber or component. For example, the mixer may be used to continuously mix or stir the slurry mixture to maintain consistent and even mixture as the caloric material melts.

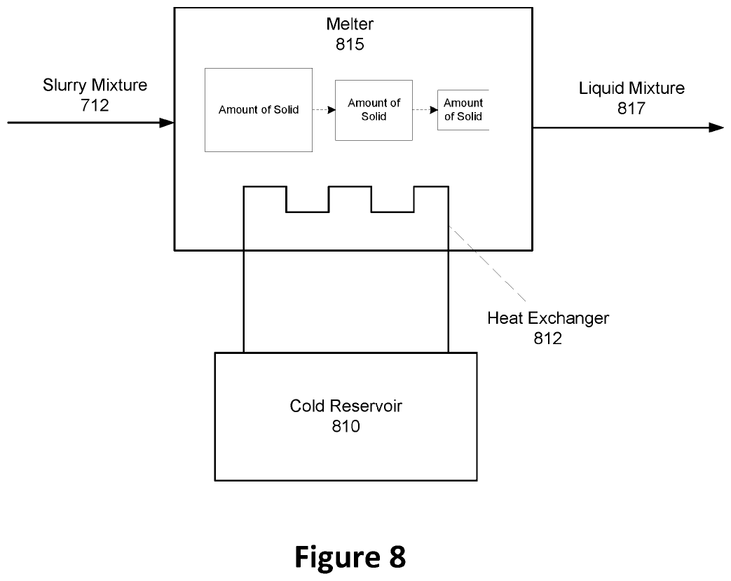

FIG. 8 illustrates an example of a melter 815 of an ionocaloric heating and cooling system, configured in accordance with some embodiments. As depicted, a melter 815 may be coupled to a cold reservoir 810 (e.g., via a heat exchanger 812). Melter 815 may be the same or similar to melting chamber 115 as described with respect to FIG. 1. Melter 815 may receive a slurry mixture 512 (e.g., from a mixer). The melter 815 may be thermally insulated and may be coupled to a cold reservoir 810. Accordingly, as the caloric material melts it absorbs heat from the cold reservoir via a heat exchanger 812. Heat may be extracted from the cold reservoir 810 by the melting caloric material until the caloric material is completely melted resulting in a liquid mixture 817. The liquid mixture 817 may then be output from the melter 815 to a separator (e.g., as described in FIG. 4 or 5.) The cold reservoir 810 may be used in any process of cooling such as refrigeration, central air cooling, electronics cooling, or any other cooling application.

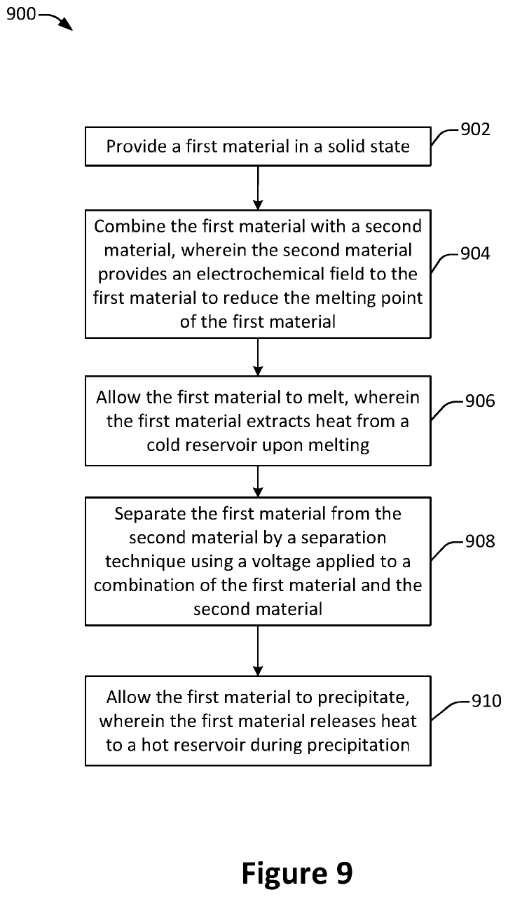

FIG. 9 illustrates a flow chart of a method of ionocaloric heating and cooling, implemented in accordance with some embodiments. In various embodiments, a method, such as method 900, may be implemented to provide heating or cooling via an ionocaloric cycle. With reference to FIG. 9, method 900 illustrates example functions or processes used by various embodiments. Although specific function blocks (“blocks”) are disclosed in method 900, such blocks are examples. That is, embodiments are well suited to performing various other blocks or variations of the blocks recited in method 900. It is appreciated that the blocks in method 900 may be performed in an order different than presented, and that not all of the blocks in method 900 may be performed.

Accordingly, method 900 may commence with operation 902 during which a first material in a solid state is provided. The first material may include one of the materials listed in FIG. 11. For example, the first material may be ethylene carbonate. Alternatively, the first material may be magnesium nitrate hexahydrate, magnesium chloride hexahydrate, sodium thiosulfate hexahydrate, sodium acetate trihydrate, nickel nitrate hexahydrate, iron nitrate hexahydrate. Iron chloride hexahydrate, cadmium nitrate tetrahydrate, room temperature liquid salts such as 1-Butyl-2,3-dimethlynlimidazolium tetrafluoroborate puruum and 1-ethyl-3-methylimidazolium nitrate, polyalcohols such as eryhritol, d-mannitol, d-dulcitol, inositol, neopentyl glycol, fatty acids such as paraffin waxes (heptadecane, octadecane) and lauric, myristic, palmitic, and stearic acids. In some examples, the first material may be provided via mechanical means such as a conveyor, piping, pump, gravity, etc. In some embodiments, the first material may be provided in many smaller pieces of the solid material, in one large solid form, or in various shapes and sizes of the solid form of the first material. For example, the first material may be in the form of a slurry (e.g., a partial solid, partial liquid) rather than a full solid to allow the first material to be pumped from a precipitator/crystallizer to a mixer/melter. In some examples, the first material may be a salt hydrate.

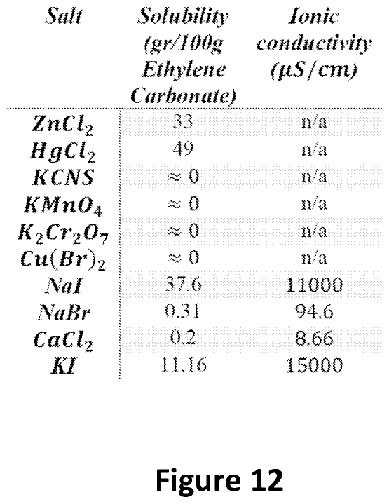

Method 900 may proceed to operation 904 during which the first material is combined with a second material. The second material may provide an electrochemical field to the first material to reduce the melting point of the first material. In some examples, the second material includes an ion concentration. For example, the second material may include one or more of the ionic materials or salts provided in FIG. 12. For example, the second material may be sodium iodide. Alternatively, the second material may be magnesium nitrate, magnesium chloride, ammonium nitrate, potassium nitrate, potassium chloride, sodium thiosulfate, lithium bromide, lithium iodide, lithium chloride, lithium carbonate, water, and ethanol. Accordingly, the ion concentration mixed with the first material may apply the electrochemical field to the first material, thus lowering a melting point of the first material. The original melting point of the first material may be at or above ambient temperature while the new melting point after mixture with the ion concentration may be below ambient temperature. In some examples in which the first material is a salt hydrate, the second material may be water (e.g., concentrated water). For example, the water may apply an electrochemical field to the salt hydrate, reducing the melting point of the salt hydrate and cooling the mixture.

Method 900 may proceed to operation 906 during which the first material is allowed to melt. The first material may extract heat from a cold reservoir upon melting. Because the melting point of the first material is lowered by the application of the electrochemical field, the first material becomes more stable as a liquid rather than a solid. Thus, the first material uses its internal heat energy to phase change to the liquid. Accordingly, the first material may absorb energy until the first material is completely converted into the liquid phase. In some embodiments, the cold reservoir may be used to perform a cooling application, such as central air conditioning, refrigeration, electronics cooling, or any other use of large cooling capacity.

Method 900 may proceed to operation 908, during which the first material is separated from the second material by a separation technique using a voltage applied to the combination of the first material and the second material. Any voltage applied separation technique may be used to separate the second material from the first material. In some embodiments, the separation technique may include electrodialysis in which the voltage is applied to the liquid mixture via electrode compartments of iodide triiodide redox couples. In other embodiments, the separation technique may include faradaic deionization in which the voltage is applied to the liquid mixture via electro-active electrodes, which serve to modulate the salt concentration through ion conversion within the electrodes themselves. In some embodiments, the separation technique may include evaporation, distillation, filtering, reverse-osmosis, or any other methods to separate a salt hydrate from water.

Method 900 may proceed to operation 910, during which the first material is allowed to precipitate. The first material may release heat to a hot reservoir during precipitation. Once the second material is separated from the first material, the melting point and freezing point of the first material may return to above ambient temperature (e.g., room temperature). Accordingly, the material may release excess energy as it crystallized back into the solid form. In some embodiments the hot reservoir may be used to perform a heating application, such as for steam generation, central air heating, or any other use of large heat input capability.

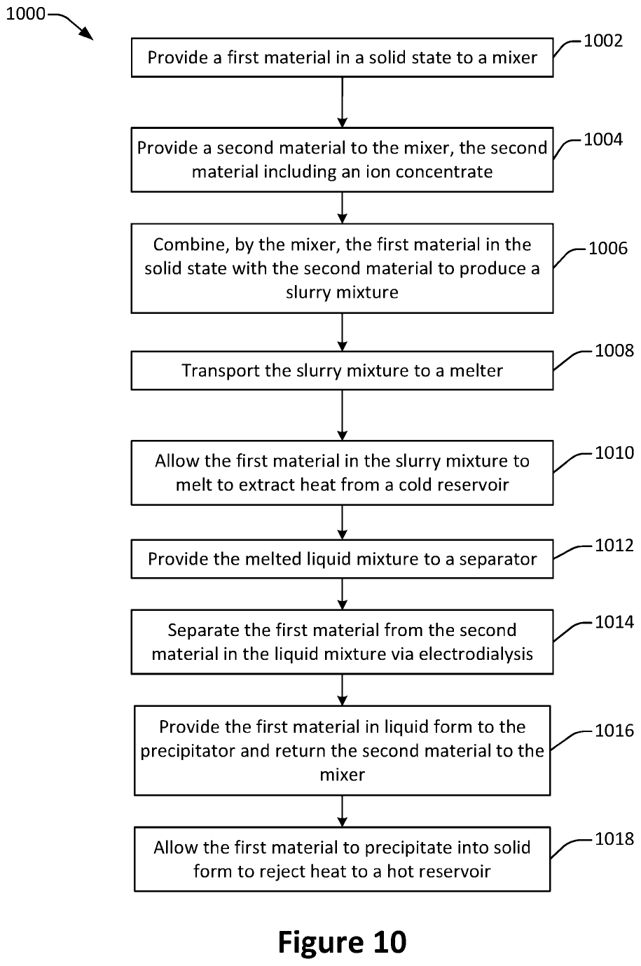

FIG. 10 illustrates a flow chart of a method of ionocaloric heating and cooling, implemented in accordance with some embodiments. In various embodiments, a method, such as method 900, may be implemented to provide heating or cooling via an ionocaloric cycle. With reference to FIG. 10, method 1000 illustrates example functions or processes used by various embodiments. Although specific function blocks (“blocks”) are disclosed in method 1000, such blocks are examples. That is, embodiments are well suited to performing various other blocks or variations of the blocks recited in method 1000. It is appreciated that the blocks in method 1000 may be performed in an order different than presented, and that not all of the blocks in method 1000 may be performed.

Accordingly, method 1000 may commence with operation 1002 during which a first material in a solid state is provided to a mixer. Method 1000 may proceed to operation 1004, during which a second material is provide to the mixer. The second material may include an ion concentration. Method 1000 may proceed to operation 1006, during which the mixer combines the first material in the solid state with the second material to produce a slurry mixture. Method 1000 may proceed to operation 1008, during which the slurry mixture is transported to a melter. Method 1000 may proceed to operation 1010, during which the first material in the slurry mixture is allowed to melt, extracting heat from a cold reservoir. Method 1000 may proceed to operation 1012, during which the melted liquid mixture is provided to a separator. Method 1000 may proceed to operation 1014, during which the first material in the liquid mixture is separated from the second material via electrodialysis. Method 1000 may proceed to operation 1016, during which the first material in the liquid form is provided to a precipitator and the second material in the form of an ion concentrate is returned to the mixer. Method 1000 may proceed to operation 1018, during which the first material is allowed to precipitate and reject heat to a hot reservoir.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A method of caloric cooling comprising:
providing a first material in a solid state;
combining the first material with a second material, wherein the second material provides an electrochemical field to the first material to reduce the melting point of the first material;
allowing the first material to melt, wherein the first material extracts heat from a cold reservoir upon melting;
separating the first material from the second material by a separation technique using a voltage applied to a combination of the first material and the second material; and
allowing the first material to precipitate, wherein the first material releases heat to a hot reservoir during precipitation.

2. The method of claim 1, wherein the first material has a melting point at or above an ambient temperature.

3. The method of claim 1, wherein the second material comprises an ion concentration to provide the electrochemical field.

4. The method of claim 1, wherein the second material comprises at least one of sodium iodide, potassium iodide, magnesium nitrate, magnesium chloride, ammonium nitrate, potassium nitrate, potassium chloride, sodium thiosulfate, lithium bromide, lithium iodide, lithium chloride, lithium carbonate, water, or ethanol.

5. The method of claim 1, wherein the separation technique comprises electrodialysis or Faradaic deionization.

6. The method of claim 5, wherein the electrodialysis comprises separating the first material from the second material by applying the voltage across electrode compartments comprising iodide triiodide redox couples.

7. The method of claim 1, wherein the first material comprises at least one of ethylene carbonate, magnesium nitrate hexahydrate, magnesium chloride hexahydrate, sodium thiosulfate hexahydrate, sodium acetate trihydrate, nickel nitrate hexahydrate, iron nitrate hexahydrate, Iron chloride hexahydrate, or cadmium nitrate tetrahydrate.

8. A system comprising:
a mixing chamber to combine a first material in a solid state with a second material wherein the second material provides an electrochemical field to the first material to reduce the melting point of the first material;
a melting chamber allowing the first material to melt, wherein the melting chamber is coupled to a cold reservoir and wherein the first material extracts heat from the cold reservoir upon melting;
a separating chamber to separate the first material from the second material via a separation technique comprising a voltage applied to a combination of the first material and the second material; and
a precipitation chamber allowing the first material to precipitate, wherein the first material releases heat to a hot reservoir coupled to the precipitation chamber during precipitation.

9. The system of claim 8, wherein the first material has a melting point at or above an ambient temperature.

10. The system of claim 8, wherein the second material comprises an ion concentration to provide the electrochemical field.

11. The system of claim 8, wherein second material comprises at least one of sodium iodide, potassium iodide, magnesium nitrate, magnesium chloride, ammonium nitrate, potassium nitrate, potassium chloride, sodium thiosulfate, lithium bromide, lithium iodide, lithium chloride, lithium carbonate, water, or ethanol.

12. The system of claim 8, wherein the separation technique comprises electrodialysis or Faradaic deionization.

13. The system of claim 12, wherein the electrodialysis comprises separating the first material from the second material by applying the voltage across electrode compartments comprising iodide triiodide redox couples.

14. The system of claim 8, wherein the first material comprises at least one of ethylene carbonate, magnesium nitrate hexahydrate, magnesium chloride hexahydrate, sodium thiosulfate hexahydrate, sodium acetate trihydrate, nickel nitrate hexahydrate, iron nitrate hexahydrate, Iron chloride hexahydrate, or cadmium nitrate tetrahydrate.

15. An apparatus comprising:
a mixer to combine a first material in a solid state with a second material wherein the second material provides an electrochemical field to the first material to reduce the melting point of the first material;
a melter allowing the first material to melt, wherein the melting chamber is coupled to a cold reservoir and wherein the first material extracts heat from the cold reservoir upon melting;
a separator to separate the first material from the second material via a separation technique comprising a voltage applied to a combination of the first material and the second material; and
a precipitator allowing the first material to precipitate, wherein the first material releases heat to a hot reservoir coupled to the precipitation chamber during precipitation.

16. The apparatus of claim 15, wherein the first material has a melting point at or above an ambient temperature.

17. The apparatus of claim 15, wherein the second material comprises an ion concentration to provide the electrochemical field.

18. The apparatus of claim 15, wherein the second material comprises at least one of sodium iodide, potassium iodide, magnesium nitrate, magnesium chloride, ammonium nitrate, potassium nitrate, potassium chloride, sodium thiosulfate, lithium bromide, lithium iodide, lithium chloride, lithium carbonate, water, or ethanol and wherein the first material comprises at least one of ethylene carbonate, magnesium nitrate hexahydrate, magnesium chloride hexahydrate, sodium thiosulfate hexahydrate, sodium acetate trihydrate, nickel nitrate hexahydrate, iron nitrate hexahydrate, Iron chloride hexahydrate, or cadmium nitrate tetrahydrate.

19. The apparatus of claim 15, wherein the separation technique comprises electrodialysis or Faradaic deionization.

20. The apparatus of claim 19, wherein the electrodialysis comprises separating the first material from the second material by applying the voltage across electrode compartments comprising iodide triiodide redox couples.
